(19) United States
(12) Patent Application Publication
(10) Pub. No.: US 2013/0117798 A1
(43) Pub. Date: May 9, 2013

(54) AUGMENTING CONTENT GENERATING APPARATUS AND METHOD, AUGMENTED BROADCASTING TRANSMISSION APPARATUS AND METHOD, AND AUGMENTED BROADCASTING RECEPTION APPARATUS AND METHOD

(71) Applicant: Electronics and Telecommunications Research In, Daejeon-si (KR)

(72) Inventors: Jeoung Lak HA, Daejeon-si (KR); Seung Chul KIM, Daejeon-si (KR); Soon Choul KIM, Daejeon-si (KR); Bum Suk CHOI, Daejeon-si (KR); Jung Hak KIM, Daejeon-si (KR); Young Ho JEONG, Daejeon-si (KR)

(73) Assignee: Electronics and Telecommunications Research Institute, Daejeon-si (KR)

(21) Appl. No.: 13/672,066

(22) Filed: Nov. 8, 2012

(30) Foreign Application Priority Data
Nov. 8, 2011 (KR) 10-2011-0115529

(51) Int. Cl. H04N 21/65; H04N 21/462

(52) U.S. Cl. 725/126; 725/132

(57) ABSTRACT

Disclosed are augmenting content generating apparatus and method, augmented broadcasting transmission apparatus and method, and augmented broadcasting reception apparatus: An augmented broadcasting transmission apparatus includes: a broadcasting content generation unit that generates broadcasting content;

a metadata generation unit that generates metadata acquiring at least one sensing information using at least one sensor and outputting sensor related augmenting content based on the acquired sensing information; and a control unit that controls transmission by performing multiplexing based on the broadcasting content and the metadata.

### CROSS-REFERENCE TO RELATED APPLICATIONS

This application claims the benefit of priority of Korean Patent Application No. 10-2011-0115529 filed on Nov. 8, 2011, all of which are incorporated by reference in their entirety herein.

### BACKGROUND OF THE INVENTION

1. Field of the Invention

The present invention relates to augmenting content generating apparatus and method, augmented broadcasting transmission apparatus and method, and augmented broadcasting reception apparatus and method, and more particularly, to augmenting content generating apparatus and method, augmented broadcasting transmission apparatus and method, and augmented broadcasting reception apparatus and method capable of more abundantly providing information provided by broadcasting services in digital broadcasting to a viewer.

2. Related Art

In digital TV broadcasting, at least one video/audio stream and a data stream are multiplexed together, which are in turn provided to a viewer through a broadcasting network. The related art (Korean Patent Laid-Open Publication No. 10-2010-0121614) discloses a technology of a variety of information measured by a sensor to a receiving terminal through the data stream, but can hardly be applied realistically due to an insufficient bandwidth of the data stream. Another related art (Korean Patent Laid-Open Publication No. KR 10-2011-0049096) provides interactive broadcasting to a viewer using a broadcasting network and the Internet network. A viewer may receive additional information through the Internet using an address of a web page related to broadcasting transferred through the data stream of the broadcasting network. In addition, even in the digital radio broadcasting according to the related art, information correlated with programs may be provided through at least one audio stream and data stream and multimedia in addition to audio may be provided according to a digital radio standard.

The related art may additionally provide information related to program production but provide only additional information to be provided to a viewer by producers at the time of producing the broadcasting programs. In addition, there may be a case in which addresses on the Internet related to the broadcasting programs are provided. However, a range of the information is not sufficient. That is, a viewer wants to more lively feel a sense of realism as well as general information relating to watching programs among the broadcasting programs and wants to change a type of broadcasting output from a viewer's terminal into their desired type. However, the related art is insufficient to satisfy the user' desire. Therefore, according to the related art, it is difficult for a viewer to know more abundant information correlated with the production of the broadcasting programs and even when the viewer knows, the viewer needs to make more efforts.

### SUMMARY OF THE INVENTION

The present invention provides augmenting content generating apparatus and method, augmented broadcasting transmission apparatus and method, and augmented broadcasting reception apparatus and method capable of allowing a viewer to know more detailed and abundant information by measuring a variety of information of a site using a sensor at the time of producing broadcasting programs and providing the measured information to the viewer in an additional data type.

The present invention also provides augmenting content generating apparatus and method, augmented broadcasting transmission apparatus and method, and augmented broadcasting reception apparatus and method capable of watching augmented broadcasting represented by several types by selecting various content providers according to a taste of a viewer and allowing a user to interactively watch augmented broadcasting content based on a content to which he/she wants to know, when the viewer watches the transmitted detailed information.

For example, the related art can watch only the information of the corresponding golf course unilaterally provided from a broadcasting station in relaying program of golf game and cannot know how to form a green flexion at a location of a current player. According to exemplary embodiments of the present invention, a viewer watches the corresponding green at a location of a current player or a location opposite thereto to more lively know site situations.

In an aspect, an augmented broadcasting transmission apparatus is provided. The augmented broadcasting transmission apparatus includes: a broadcasting content generation unit that generates broadcasting content; a metadata generation unit that generates metadata acquiring at least one sensing information using at least one sensor and outputting sensor related augmenting content based on the acquired sensing information; and a control unit that controls transmission by performing multiplexing based on the broadcasting content and the metadata.

The augmented broadcasting transmission apparatus may further include: a basic augmenting content generation unit that generates basic augmenting content independent of the sensor.

The control unit may multiplex and transmit the broadcasting content and the metadata into a video stream type, an audio stream type, and a data stream type.

The control unit may transmit the broadcasting content among the augmented broadcasting content generated by multiplexing the augmenting content and the broadcasting content through a broadcasting network, transmit the augmenting content through different transmission networks according to the amount and characteristics of the augmenting content, (i) transmit all of the augmenting content through the broadcasting network, (ii) transmit a part of the augmenting content through the broadcasting network and additionally transmits the rest augmenting content that are not provided from the broadcasting network through a communication network, and (iii) transmit all of the augmenting content through the communication network.

The sensor may sense pan, tilt information of a camera when the at least one sensor is applied to the camera, an actor, or a broadcasting site participating in broadcasting and the sensor is applied to the camera.

The augmented broadcasting transmitting apparatus may use any one of H.264, MPEG-4, or MPEG-2 to transmit the augmented broadcasting content.

When the augmented broadcasting transmission apparatus transmits the augmented broadcasting content using an MPEG-2, the augmented broadcasting content may be transmitted to a single transmission channel and the single transmission channel may be configured of at least one logical channel, and each logical channel may include additional information correlated with the augmented broadcasting content provided to the receiving side or the augmented broadcasting content included in the transmission channel.

In another aspect, an apparatus for generating sensor related augmenting content correlated with broadcasting content is provided. The apparatus includes: a sensor relating augmenting content generation unit that acquires at least one sensing information using at least one sensor and generates the sensor related augmenting content correlated with the broadcasting content based on the acquired sensing information; and a metadata generation unit that generates metadata including correlation information of the sensor related augmenting content and the broadcasting content.

The apparatus may further include: a basic augmenting content generation unit that generates basic augmenting content.

In another aspect, an augmented broadcasting reception apparatus is provided. The augmented broadcasting reception apparatus includes: a content receiving unit that receives broadcasting content, augmenting content correlated with the broadcasting content and augmenting content including sensing information acquired through at least one sensor, and metadata including correlation information of the broadcasting content and the augmenting content through a broadcasting network; a metadata parsing unit that pareses the metadata to request and receive the augmenting content that are not received through the broadcasting network through a communication network; a synchronization unit that media-synchronizes the broadcasting content and the augmenting content; and a content output unit that outputs the synchronized content.

The content output unit may include: a select unit that allows a user to receive as an input a selection for the augmenting content to be added to the broadcasting content among the augmenting content and provides the selected augmenting content in the user's desired type; and an output unit that outputs the augmenting content and the broadcasting content provided from the select unit.

The select unit may receive the selection for the sensor related augmenting content to be added to the broadcasting content as an input and provide the selected augmenting content in the user's desired type.

The metadata parsing unit may include: a parsing unit that parses the metadata; a requesting unit that requests the augmenting content that are not received through the broadcasting network according to the parsed metadata; a receiving unit that receives the requested augmenting content; and a storage unit that stores the received augmenting content for the media synchronization for a predetermined time.

The augmented broadcasting reception apparatus may further include: a buffering unit that buffers the broadcasting content until the augmenting content that are not received from the content receiving unit are received so as to facilitate media synchronization of the broadcasting content and the augmenting content.

The metadata parsing unit may previously receive and parse the metadata so as to facilitate the media synchronization since it takes time to receive the augmenting content that are not received through the broadcasting network through the communication network.

The metadata parsing unit may further include an augmented broadcasting watching select unit that selects whether the augmenting content is watched and if it is determined that the augmenting content is not watched, does not output the augmenting content.

The metadata parsing unit may transmit the augmenting content correlated with the metadata to a synchronization unit when the augmenting content correlated with the metadata is included in the augmenting content received through the broadcasting network and the requesting unit may request the augmenting content correlated with the metadata parsed by the parsing unit through the communication network when the augmenting content correlated with the metadata is not included in the augmenting content received through the broadcasting network.

In another aspect, an augmented broadcasting transmission method is provided. The augmented broadcasting transmission method includes: generating broadcasting content; acquiring at least one sensing information using at least one sensor and generating metadata outputting sensor related augmenting content based on the acquired sensing information; and controlling transmission by performing multiplexing based on the broadcasting content, the augmenting content, and the metadata.

In another aspect, a method for generating sensor related augmenting content correlated with broadcasting content is provided. The method includes: acquiring at least one sensing information using at least one sensor and generating at least one sensor related augmenting content correlated with the broadcasting content based on the acquired sensing information; and generating metadata including correlation information of the broadcasting content and the sensor related augmenting content.

In another aspect, an augmented broadcasting receiving method is provided. The augmented broadcasting receiving method includes: receiving broadcasting content, augmenting content correlated with the broadcasting content and augmenting content including sensing information acquired through at least one sensor, and metadata including correlation information of the broadcasting content and the augmenting content through a broadcasting network; parsing the metadata to request and receive the augmenting content that are not received through the broadcasting network through a communication network; media-synchronizing the broadcasting content and the augmenting content; and outputting the synchronized content.

### BRIEF DESCRIPTION OF THE DRAWINGS

FIG. 1 is a diagram for describing a system structure of a smart TV.

FIG. 2 is a diagram showing a TV screen of an education program according to an exemplary embodiment of the present invention of augmented broadcasting.

FIG. 3 is a block diagram showing a structure of a digital broadcasting system to which augmented broadcasting transmission apparatus and reception apparatus according to an exemplary embodiment of the present invention are applied.

FIG. 4 is a block diagram reconfiguring a configuration of the system of FIG. 3 as a concept of participants of broadcasting services.

FIG. 5 is a block diagram showing a configuration of the relationship among content providers, service providers, network providers, and service consumers of FIG. 4.

FIG. 6 is a block diagram schematically showing an augmented broadcasting transmission apparatus according to an exemplary embodiment of the present invention.

FIG. 7 is a diagram exemplarily showing augmented broadcasting content multiplexing of the augmented broadcasting transmission apparatus according to the exemplary embodiment of the present invention.

FIG. 8 is a diagram for describing various combinations of the broadcasting content and the augmenting content of the augmented broadcasting transmission apparatus according to the exemplary embodiment of the present invention.

FIG. 9 is a diagram showing a configuration of a sensor for configuring sensor related augmenting content of the augmented broadcasting transmission apparatus according to the exemplary embodiment of the present invention.

FIG. 10 is a diagram in detail a structure of the broadcasting content and the sensor related augmenting content using the sensor of the augmented broadcasting transmission apparatus according to the exemplary embodiment of the present invention.

FIG. 11 is a diagram exemplarily showing three types of transmitting augmented broadcasting content of the augmented broadcasting transmission apparatus according to the exemplary embodiment of the present invention.

FIG. 12 is a diagram showing the multiplexing of the augmented broadcasting content when the augmented broadcasting transmission apparatus according to the exemplary embodiment of the present invention uses MPEG-2.

FIG. 13 is a block diagram schematically showing an augmenting content generation apparatus according to another exemplary embodiment of the present invention.

FIG. 14 is a detailed block diagram showing in detail a sensor information generation unit of an augmenting content generating apparatus according to another exemplary embodiment of the present invention.

FIG. 15 is a functional configuration diagram of an augmented broadcasting reception apparatus according to another exemplary embodiment of the present invention.

FIG. 16 is a block diagram schematically showing an augmented broadcasting reception apparatus according to another exemplary embodiment of the present invention.

FIG. 17 is a detailed block diagram in detail showing a metadata parsing unit of an augmented broadcasting reception apparatus according to another exemplary embodiment of the present invention.

FIG. 18 is a detailed block diagram in detail showing a content output unit of an augmented broadcasting reception apparatus according to another exemplary embodiment of the present invention.

FIG. 19 is a flow chart for describing a method of determining whether augmenting content is output according to a reception of metadata by a metadata parsing unit of an augmented broadcasting reception apparatus according to another exemplary embodiment of the present invention.

FIG. 20 is a flow chart schematically showing an augmented broadcasting transmission method according to an exemplary embodiment of the present invention.

FIG. 21 is a flow chart schematically showing an augmenting content generation method according to another exemplary embodiment of the present invention.

FIG. 22 is a flow chart schematically showing an augmented broadcasting reception method according to another exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

### General Augmented Broadcasting

A smart TV can execute content or applications on the Internet while executing TV watching or the Internet search, by simultaneously providing the Internet function to the existing digital TV broadcasting system.

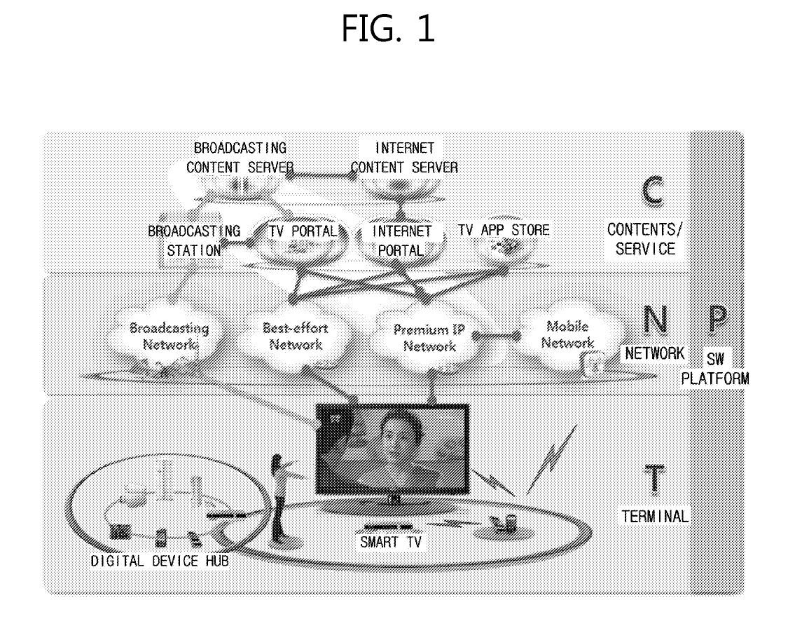

FIG. 1 is a diagram for describing a system structure of a smart TV. As shown in FIG. 1, the smart TV may use various content on the Internet through a wired and wireless Internet network while using broadcasting services through a broadcasting network. In addition, the smart TV may also be operated as a hub of various digital devices in the home.

Augmented broadcasting means a type of naturally fusing augmenting content by deviating from a type of unilaterally watching broadcasting programs transmitted from the broadcasting station, in digital TV broadcasting according to the related art to increase the sense of realism and the sense of movement of a viewer and allowing a viewer to select services provided by an augmented broadcasting content provider. To this end, a TV and a portable receiving terminal need to receive augmenting content capable of augmenting the broadcasting programs in addition to the broadcasting programs (hereinafter, referred to as broadcasting content) according to the related art that are sent out from the broadcasting station. The broadcasting station may send output the augmenting content and the augmenting service related metadata interactive with the broadcasting programs, together with the broadcasting programs.

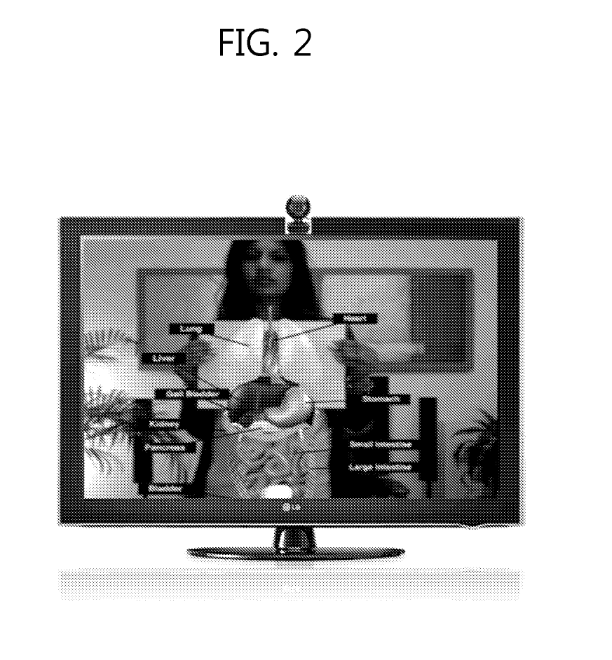

FIG. 2 is a diagram showing a TV screen of an education program according to an exemplary embodiment of the present invention of augmented broadcasting. As shown in FIG. 2, when a person holding an anatomical chart as the broadcasting content is sent out from the broadcasting station, more detailed information on the corresponding anatomical chart may be shown as the augmenting content on the TV program provided. Therefore, a viewer may show detailed information correlated with each internal organ or a three-dimensional graphic screen of each internal organ together. The three-dimensional graphic information can be shown in turns at various angles by a viewer. In particular, the augmenting content may not be output according to the selection or not of the user. In this case, the user may enjoy only the existing TV broadcasting content.

For the augmented broadcasting, the augmenting content needs to be produced at the time of producing the broadcasting programs and the metadata including information regarding output time, output location, processing event, and the like, of the augmenting content is simultaneously produced in the broadcasting programs. At the time of producing the broadcasting programs, the augmented broadcasting authoring tools effectively generate the metadata and a multiplexer and a transmission server may multiplex and send out the generated metadata together with the broadcasting programs. The smart TV receiving terminal secures the related augmenting content based on the metadata while outputting the broadcasting programs and provides the augmenting content to the viewer, together with the broadcasting programs according to regulations defined in the metadata. The augmenting content may be stored in an auxiliary storage device of the receiving terminal or proved by any content providers on the Internet and the information thereon may be provided using the metadata.

The augmented broadcasting system may transmit and receive the broadcasting content, the metadata, the augmenting content through the broadcasting network and may transmit and receive the metadata and the augmenting content through the communication network. A method for using a broadcasting network and a communication network may include the following three methods. 1) In addition to the broadcasting content, the augmenting content and the metadata are transmitted together from the broadcasting network and are received by the receiving terminal to provide the augmented broadcasting, 2) only the broadcasting content and the metadata are transmitted from the broadcasting network and the receiving terminal receives the augmenting content correlated therewith from the communication network to receive the augmented broadcasting, 3) only the broadcasting content and the metadata are transmitted from the broadcasting network and the receiving terminal receives the additional metadata and the augmenting content correlated therewith from the communication network to receive the augmented broadcasting. There are two methods that allow a receiving terminal to access a uniform resource locator (URL) or a uniform resource identifier (URI) based on the metadata received from the broadcasting network and receive the metadata and the augmenting content correlated therewith. 1) When the receiving terminal accesses the URL or the URI, a method for directly transferring the metadata and the augmenting content associated therewith can be implemented and 2) when the receiving terminal accesses the URL or the URI, a method for selecting any one of several metadata or the augmenting content by the user in a type such as home pages, and the like, can be implemented.

### Structure of Augmented Broadcasting Transmission and Reception System

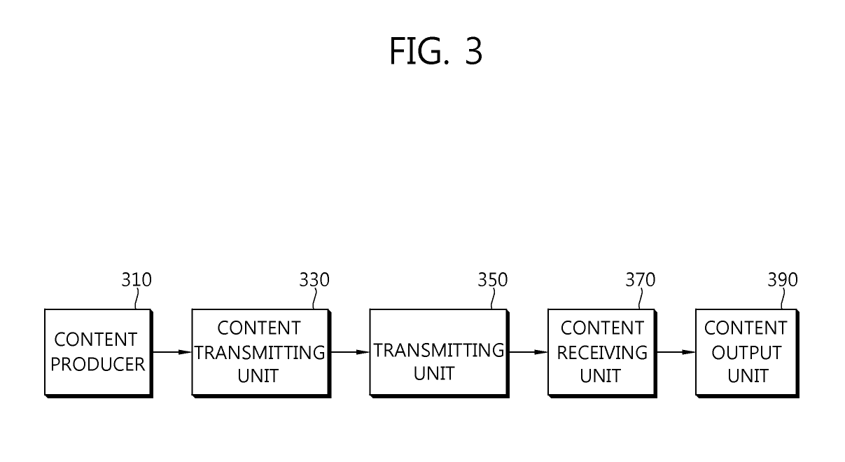

FIG. 3 is a block diagram showing a structure of a digital augmented broadcasting system to which the augmented broadcasting transmission apparatus and reception apparatus according to an exemplary embodiment of the present invention are applied. As shown in FIG. 3, a digital augmented broadcasting system according to an exemplary embodiment of the present invention may include a content production unit 310, a content transmitting unit 330, a transmitting unit 350, a content receiving unit 370, and a content output unit 390. The augmented broadcasting content is produced by the content production unit 310 and are transferred to each viewer through the transmitting unit 350 via the content transmitting unit 330 and the receiving terminal of the viewer receives the augmented broadcasting content through the content receiving unit 370 and outputs the augmented broadcasting content through the content output unit 390 such as a display or a speaker. For the augmented broadcasting, the content production unit 310 produces the information of the augmenting content and the metadata showing the relationship between two content together, in addition to the broadcasting content. The content transmitting unit 330 is changed into a format that can transmit the broadcasting content or the augmenting content meeting a transmission type of the transmitting unit 350. The transmitting unit 350 first has a type of the broadcasting network and is relayed by a relay station. The transmitting unit 350 includes the communication network so as to transmit the augmenting content and the content output unit 390 may include another output unit in addition to the display or the speaker. The transmitted and received content is encoded/decoded and is subjected to a process of error correction, modulation and demodulation, and the like, but these procedures are not directly correlated with the features of the present invention and therefore, the description thereof will be omitted.

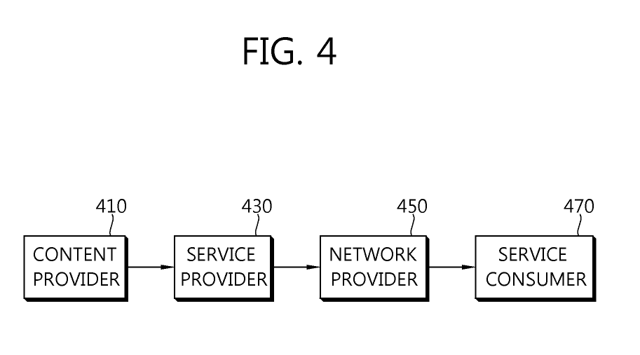

FIG. 4 is a block diagram reconfiguring a configuration of a system of FIG. 3 as a concept of participants of broadcasting services. As shown in FIG. 4, when showing the content transmission and reception system according to the exemplary embodiment of the present invention as the concept of the participants of the broadcasting services, the system is configured to include content providers 410, service providers 430, network providers 450, and service consumers 470. The content providers 410, which are persons providing the augmented broadcasting content in a type such as a sale, and the like, directly participate in the production of the augmented broadcasting content or resell the produced augmented broadcasting content. The augmented broadcasting content can be produced by an independent content producing business or a person. The reselling of the augmented broadcasting content may be performed by collecting the produced augmented broadcasting content and being transferred to the service providers 430 or may be performed by being directly sold to the service consumers 470. The service providers 430, which are persons providing the broadcasting services, serve to organize the augmented broadcasting content according to the broadcasting scheduling and transfer the organized augmented broadcasting content to viewers. The network providers 450 serve to transmit the content using a transmission path through which the augmented broadcasting content is transmitted. The used network may include the broadcasting network and the wired and wireless communication network. The service consumers 470, which are viewers and users, use the broadcasting services or the broadcasting content. The terminals used by the service consumers 470 have the content receiving unit 270 and the content output unit 390, together. One provider may serve as both of the content providers 410 and the service providers 430 and may also serve as both of the service providers 430 and the network providers 450. The existing broadcasting station may often perform these three roles together.

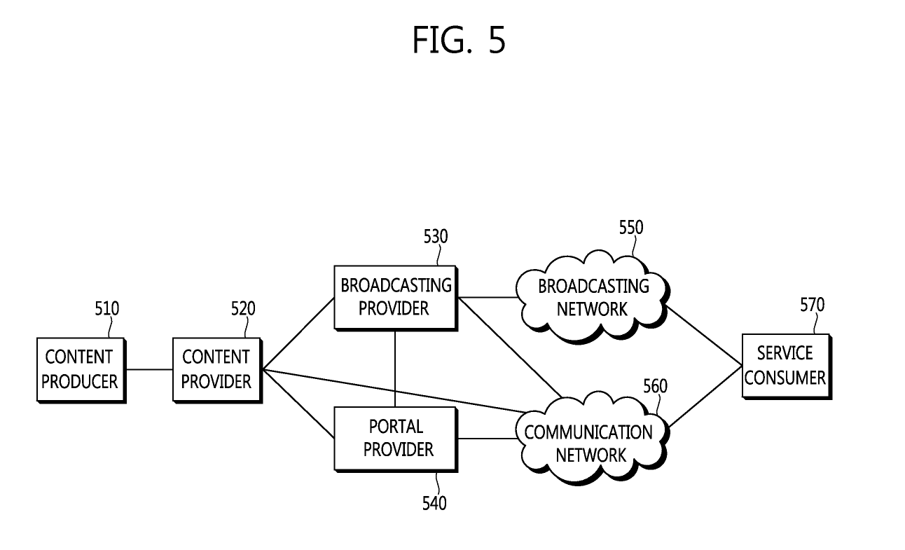

FIG. 5 is a block diagram showing a configuration of the relationship among the content providers 410, the service providers 430, the network providers 450, and the service consumers 470 of FIG. 4. As shown in FIG. 5, these devices 410, 430, 450, and 470 form a relationship in which a plurality of relationships are intricate as an N:N:N relationship to one another.

The exemplary embodiment of the present invention considers the use of the smart TV and the two-way broadcasting that can additionally provide the information that is not provided from a broadcasting network 550 using a wired and wireless communication network 560. However, when the amount of information of the sensors to be provided is small enough to be easily transmitted from the broadcasting network 550, it is possible to perform services using only the existing digital broadcasting network.

The content providers 410 are configured of at least one content provider 520 and cooperate with at least one content producer 510. As described above, the content providers 410 may be the same persons as the content producers 510. The service providers 430 may be configured of broadcasting providers 530 or portal providers 540.

The broadcasting providers 530 receive the augmented broadcasting content from at least one content provider 520 or directly produce the augmented broadcasting content to provide the broadcasting services. The broadcasting content is provided through the broadcasting network 550 and when the amount of augmenting content making the broadcasting content more abundant is small, the augmenting content is provided through the broadcasting network 550, when the amount thereof is large, the broadcasting content may be provided through the wired and wireless communication network 560. The network providers 450 may each provide the broadcasting network 550 or the communication network 560. The broadcasting network 550 or the communication network 560 provides a path through which the augmented broadcasting content may be provided to the broadcasting providers 530, the content providers 520, the portal providers 540, and the service consumers 570.

The portal providers 540 may directly provide the augmented broadcasting content to the service consumers 570 through the contract with the broadcasting providers 530 and the content providers 520 and provide the information on the content providers 520 having the augmented broadcasting content to the service consumers 570, such that the service consumers 570 may receive the augmented broadcasting content from the corresponding content providers 520. The portal providers 540 provide the augmented broadcasting content, which is directly provided to the service consumers 570 or provided to the service consumers 570 through the content providers 520, through the wired and wireless communication network 560. The aspect of the augmenting content that may receive the single broadcasting content from the plurality of portal providers or content providers may be different. For example, provider A may provide information on a golf course in two-dimensional graphics but provider B may provide the information on the golf course in three-dimensional graphics and the service consumers 570 may selectively use the services of the content providers.

### Augmented Broadcasting Transmission Apparatus

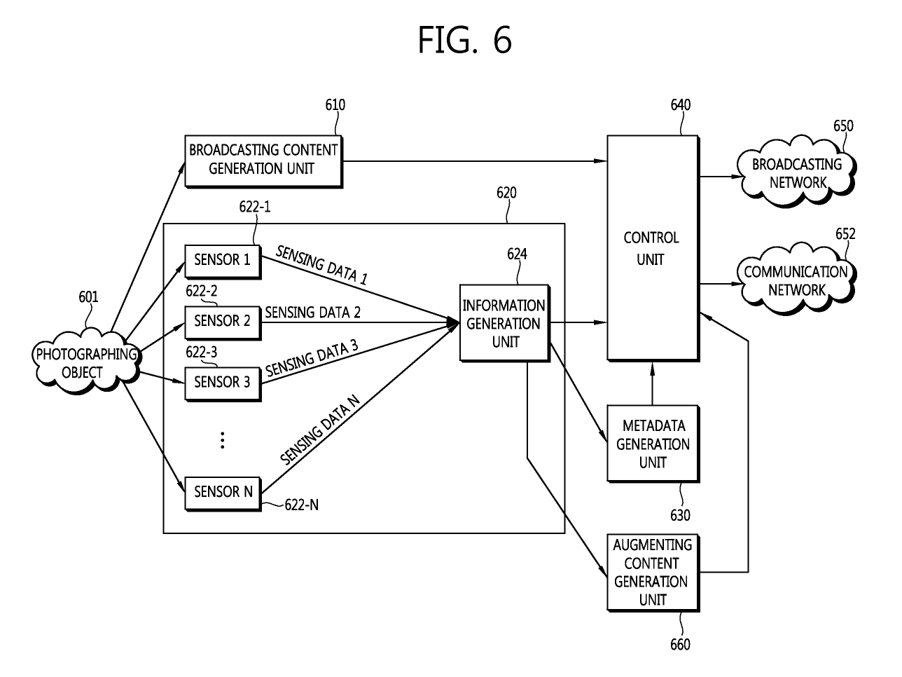

FIG. 6 is a block diagram schematically showing an augmented broadcasting transmission apparatus according to an exemplary embodiment of the present invention. As shown in FIG. 6, the augmented broadcasting transmission apparatus of the exemplary embodiment of the present invention may include a broadcasting content generation unit 610, a sensing information generation unit 620, a metadata generation unit 630, a control unit 640, and an augmenting content generation unit 660. In this configuration, the sensing information generation unit 620 may include a sensing information collection unit 622 and an information generation unit 624 and the sensing information collection unit 622 may include at least one sensor 622-1, 622-2, 622-3, . . . , 622-N.

The augmented broadcasting transmission apparatus according to the exemplary embodiment of the present invention may directly generate other basic augmenting content in addition to the sensor related augmenting content. In this case, the augmenting content may include the basic augmenting content that has nothing to do with the sensor and the sensor related augmenting content. In addition, the basic augmenting content may be generated by a third party rather than by the broadcasting content producers.

As described above, the augmented broadcasting transmission apparatus according to the exemplary embodiment of the present invention is an apparatus that transmits augmented broadcasting content obtained by synthesizing the broadcasting content with the augmenting content supporting the broadcasting content to a receiving side through the broadcasting network 650 or the communication network 652.

The broadcasting content generation unit 610 generates the broadcasting content of broadcasting that photographs a photographing target 601. The broadcasting content 610 is the same content as the broadcasting programs that are broadcast from the digital TV according to the related art. Therefore, even though the content providers 520 and the broadcasting providers 530 are different, the broadcasting content is unchanged. For example, the case in which the augmented broadcasting content differently appears at different receiving sides means that the augmenting content added to the broadcasting content is different but does not mean that the broadcasting content is different. The broadcasting content generation unit 610 takes the photographing target 601 using a photographing device such as a camera and generates the broadcasting content based on the taken video. The broadcasting content is transmitted to the control unit 640 and then, multiplexed with the augmenting content to form the augmented broadcasting content. As described above, the augmenting content may be added or may not be added to the broadcasting content by the selection of the content producers or the receiving side but the broadcasting content is transmitted to the receiving side through the control unit 640 at all times. The broadcasting content is transmitted to the receiving side only through the broadcasting network 650 except for exceptions.

The sensing information generation unit 620 may include the sensing information collection unit 622 and the information generation unit 624 and the sensing information collection unit 622 may collect at least one sensing data using at least one sensor 622-1, 622-2, 622-3, . . . , 622-N and may include the information generation unit 624 that integrates the acquired sensing data to generate the sensing information. Referring to FIG. 6, it can be appreciated that the sensing information generation unit 620 includes several sensors 622-1, 622-2, 622-3, . . . , 622-N. For example, the sensor 1 622-1 may be a sensor that is attached to the camera to sense the information on tilt, zoom, and the like, of the camera. The sensor 2 622-2 may be a sensor that is applied to the photographing target 601 to sense the current state of the photographing object. The sensor 3 622-3 may be a temperature sensor, an underwater sensor, an illumination sensor, a gravity sensor, and the like, as a sensor that is applied to surrounding environment of the photographing target 601. The information acquired by sensing the photographing target 601 by the sensor 1 622-1 is sensing data 1, wherein the sensing data 1 is transmitted to the information generation unit 624. Similarly, the sensor 2 622-2 acquires the sensing data 2, the sensor 3 622-3 acquires the sensing data 3, and the sensor N 622-N acquires the sensing data N. The augmenting content generation unit 660 may generate the sensor related augmenting content based on the acquired sensing data 1 to N. The sensing data is sensed by different sensors, respectively, and thus, a plurality of sensing data may be acquired. The sensor related augmenting content generated based on the plurality of sensing information may also be in plural. Therefore, as described above, several sensor related augmenting content may be generated in a single broadcasting content and several types of augmented broadcasting may be used according to the selection of the content producers or the receiving side. The generated sensing information is transmitted to the metadata generation unit 630, which is used to generate the metadata and is transmitted to the augmenting content generation unit 660, which is used to generate the sensor related augmenting content. As described above, the augmenting content generation unit 660 may also generate the basic augmenting content. The augmenting content generated by the augmenting content generation unit 660 are transmitted to the control unit 640. The augmenting content entering the control unit 640 may be transmitted through the broadcasting network 650 and may be transmitted through the communication network 652 according to the amount and character of the augmenting content. The augmenting content may include the sensor related augmenting content. In this case, the broadcasting content is multiplexed based on the augmenting content including the sensor related augmenting content and is transmitted.

The metadata generation unit 630 generates the metadata including the augmenting content related information. The sensor related augmenting content may be output from the receiving side through the metadata. The metadata are data that provide the information on the broadcasting content and the augmenting content indicating presence and absence of the augmenting content, the location stored in the augmenting content, and the like. In addition, the metadata may also include the information on the output time, the output location, or the processing event of the augmenting content. The metadata generation unit 630 generates the metadata including the augmenting content related information. The generated metadata is transmitted to the control unit 640.

The control unit 640 multiplexes the broadcasting content, the metadata, and at least one sensor related augmenting content to generate the augmented broadcasting content. As described above, when the broadcasting content producers directly produce the basic augmenting content in addition to the sensor related augmenting content, the augmenting content including the sensor related augmenting content is multiplexed with the broadcasting content and the metadata to generate the augmented broadcasting content. Unlike this, when the basic augmenting content is produced by other content producers rather than by the broadcasting content producers, the augmented broadcasting transmission apparatus according to the exemplary embodiment of the present invention multiplexes the sensor related augmenting content, the broadcasting content, and metadata including correlation information of the augmenting content including the sensor related augmenting content and the broadcasting content to generate the augmented broadcasting content and then, be transmitted to the receiving side.

The control unit 640 may multiplex at least one augmenting content in a single broadcasting content in several types to generate at least one augmented broadcasting content. Here, the control unit 640 may multiplex the broadcasting content and the augmenting content, respectively, and multiplex the broadcasting content and the augmenting content together. The control unit 640 may transmit the generated augmented broadcasting content in a broadcasting type. Alternatively, the augmented broadcasting content may be transmitted in a video on demand (VoD) type. When the control unit 640 transmits the augmented broadcasting content in the Vod type, the augmented broadcasting content may be transmitted in a multicasting type according to the demand of the receiving side.

The control unit 640 serves to control the transmission through the transmission networks 650 and 652 in addition to the function of multiplexing the broadcasting content and the augmenting content. As described above, the transmission networks 650 and 652 may include the broadcasting network 650 and the communication network 652. The control unit 640 first transmits the broadcasting content among the augmented broadcasting content through the broadcasting network 650. However, the augmenting content may also be transmitted to the broadcasting network 650 and may also be transmitted to the communication network 652, which is determined according to the amount and character of the augmenting content. First, all the augmenting content may be transmitted through the broadcasting network 650. Second, a part of the augmenting content is provided to the broadcasting network 650 and the rest augmenting content that is not provided from the broadcasting network 650 may be additionally transmitted through the communication network 652. The reason is that capacity transmitted by the broadcasting network 650 is limited. Therefore, the augmenting content transmitted through the broadcasting network 650 may reach transmission threshold capacity of the broadcasting network 650. Third, all the augmenting content may be transmitted through the communication network 652.

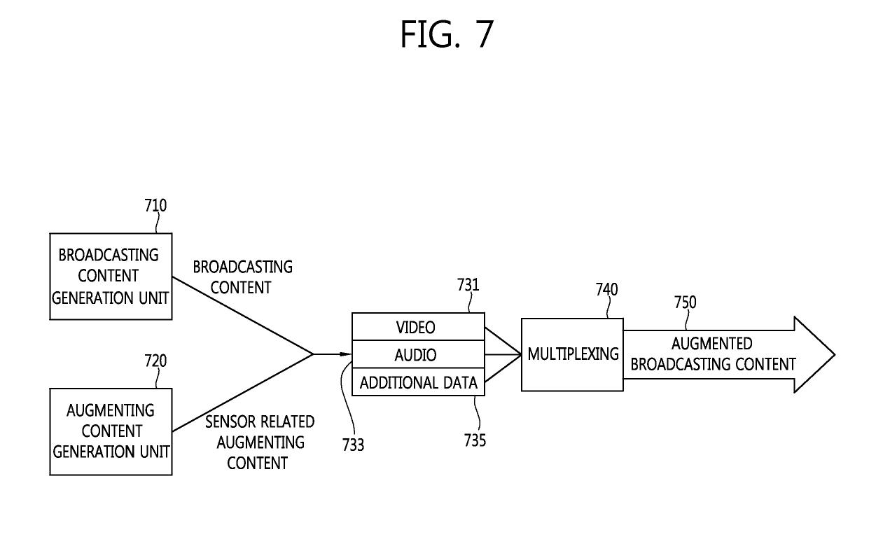

FIG. 7 is a diagram exemplarily showing augmented broadcasting content multiplexing of the augmented broadcasting transmission apparatus according to the exemplary embodiment of the present invention. A broadcasting content generation unit 710 generates the broadcasting content and an augmenting content generation unit 720 generates the sensor related augmenting content. The generated broadcasting content and the sensor related augmenting content is transmitted through a video stream 731, an audio stream 733, and an additional data stream 735 and are synthesized as augmented broadcasting content 750 through a multiplexing process 740 in the control unit 640.

As described above, the augmented broadcasting content 750 may be provided in broadcasting as in the TV broadcasting of the related art and may also be provided in a VoD type according to the demand of the viewers. The VoD may also be transmitted in the multicasting according to the demand of a plurality of viewers. One augmented broadcasting content 750 received by the receiving terminal of the viewer is configured by multiplexing (740) at least one video stream 731, at least one audio stream 733, or at least one additional data stream 735 and is transmitted to the viewers. These video stream 731, audio stream 733, and data stream 735 may include the broadcasting content and the sensor related augmenting content. That is, when the broadcasting content may be generally multiplexed and transmitted when being transmitted and the sensor related augmenting content may be multiplexed and transmitted when being transmitted. As described above, the broadcasting content and the sensor related augmenting content may be multiplexed together or may each be multiplexed and may be transmitted without being multiplexed, if necessary. The augmented broadcasting transmission apparatus according to the exemplary embodiment of the present invention provides the information on presence and absence of the augmenting content or the augmenting content to the additional data of the additional data stream 735, such that the receiving terminal may receive the augmenting content through the communication network. However, when the amount of augmenting content is small, the augmenting content may be transmitted while being directly included in the additional data stream 735.

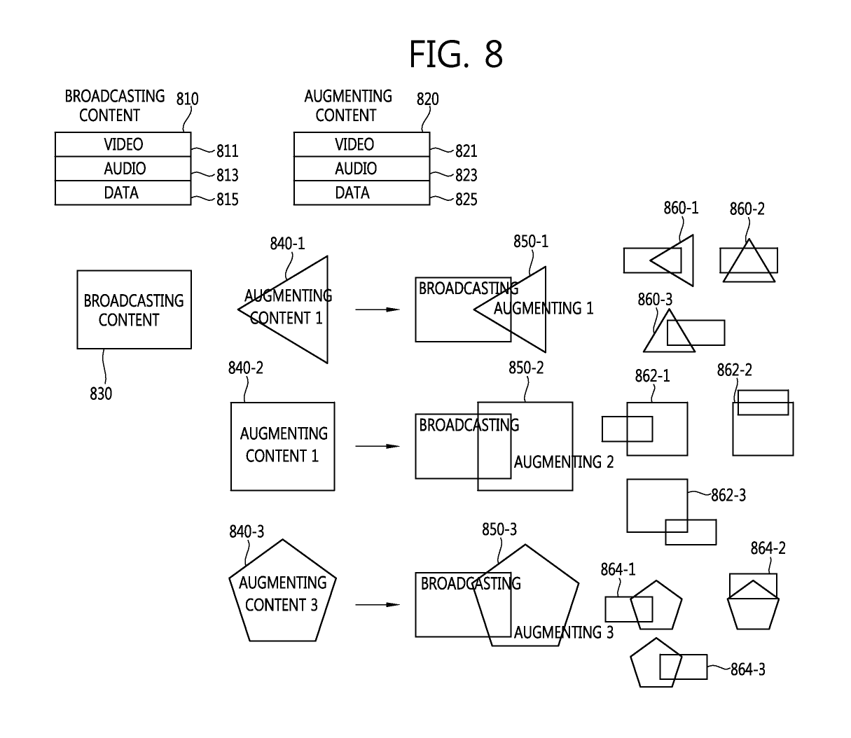

FIG. 8 is a diagram for describing various combinations of the broadcasting content and the augmenting content of the augmented broadcasting transmission apparatus according to the exemplary embodiment of the present invention. As shown in the upper part of FIG. 8, broadcasting content 820 and augmenting content 820 are configured in videos 811 and 821, audios 813 and 823, and data 815 and 825 types. Further, as shown in the lower part of FIG. 8, several augmenting content 840-1, 840-2, and 840-3 may be combined with one of the broadcasting content 830 and thus, various augmented broadcasting content may be produced.

The broadcasting content 810 is a content of the broadcasting programs of the related art that generally produces, edits, and broadcasts the video 810 and the audio 813 from the broadcasting station. Further, the broadcasting content 810 may be transmitted together with the data 815 at the time of broadcasting. It is possible for a user to watch more various broadcasting programs by adding more videos 811 and audios 813 to data 815. In the augmented broadcasting transmission apparatus according to the exemplary embodiment of the present invention, the case in which the additional information additionally fetching the augmenting content 820 through the communication network is included in the data stream will be described. The information may be a level of a flag informing only whether the augmenting content 820 correlated with the broadcasting content 810 is present or a level informing both of the type and content of augmenting content 820 correlated with the broadcasting content 810. Further, the information includes an address or positional information capable of fetching the augmenting content 820 correlated with the broadcasting content 810 and a type of the information may take a uniform resource locator (URL) type or a uniform resource identifier (URI) type. That is, the information serves to guide the receiving terminal so as to fetch the augmenting content 820 related to the broadcasting content 810 transmitted to the broadcasting network through the communication network. The augmenting content 820, which are content correlated with the broadcasting content 810, may provide the more increased sense of realism of the broadcasting programs to viewers, such that the viewers may more effectively enjoy the broadcasting programs. The augmenting content 820 according to the exemplary embodiment of the present invention may mean the augmenting content 820 correlated with the information measured using the sensor in the production site of the broadcasting programs, which is media that may be transmitted for a viewer to feel several environments measured in the production site.

The augmenting content 840-1, 840-2, and 840-3 for a single broadcasting content 830 may be shown in various types 840-1, 840-2, and 840-3. The reason is that different types of augmenting content 840-1, 840-2, and 840-3 may be configured according to producers and providers of the augmenting content 840-1, 840-2, and 840-3 providing the augmenting content 840-1, 840-2, and 840-3 even for a value of one sensor measured in the photographing site of the same broadcasting content 830. The viewer may select the producers and the providers of the augmenting content 840-1, 840-2, and 840-3 meeting his/her own taste among the producers and the providers of the plurality of augmenting content 840-1, 840-2, and 840-3 and download and receive the selected content. In this case, the broadcasting content 830 and the augmenting content 840-1, 840-2, and 840-3 are played simultaneously. Therefore, a plurality of augmented broadcasting content 850-1, 850-2, and 850-3 may be generated. The user may play different types of augmenting content 850-1, 850-2, and 850-3 in the single broadcasting content 830 provided from the broadcasting station and again change the augmenting content 860-1, 860-2, and 860-3 types according to the taste of the user. For example, when the augmenting content 840-1 of company A is played in the broadcasting content 830, it is basically played in the augmented broadcasting content 860-1 type, but the user again changes the broadcasting content 860-1 so as to be changed into the augmented broadcasting content 860-2 or the augmented broadcasting content 860-3 type. In the same principle, the augmenting content provided by the producers and the providers of another augmenting content may also be played in a viewer' desired type 862-1, 862-2, 862-3, 864-1, 864-2, and 864-3.

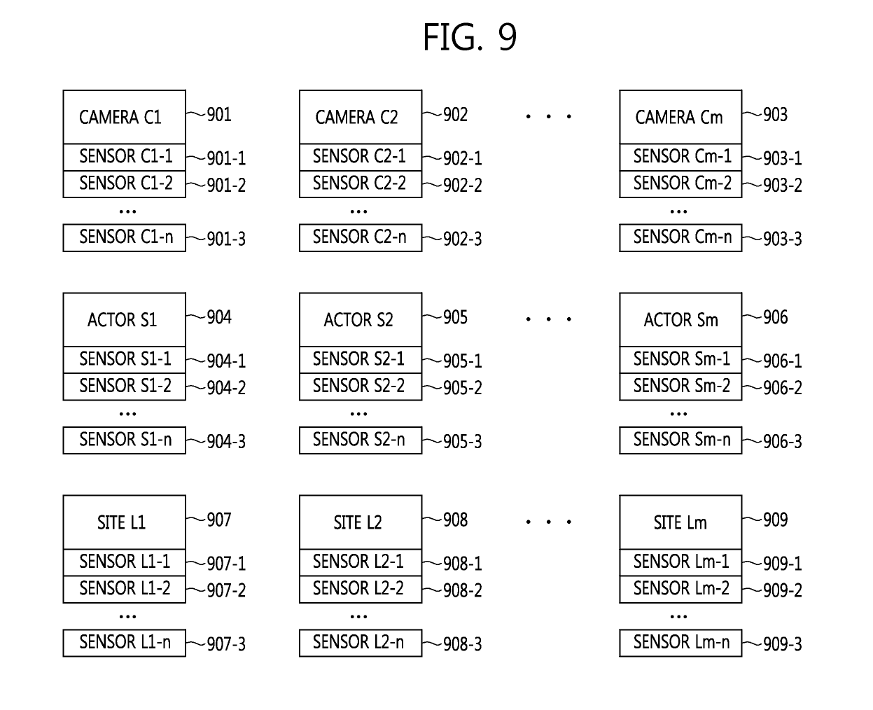

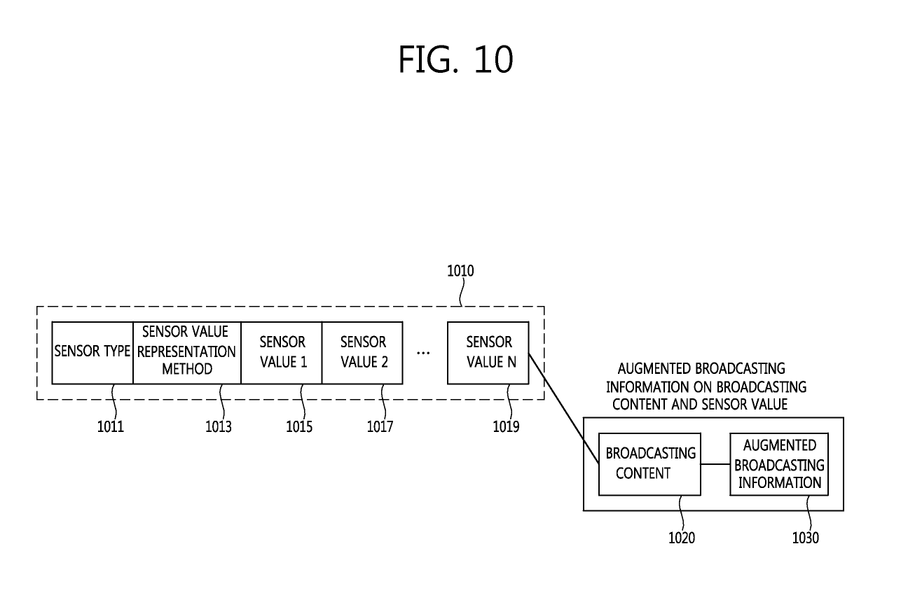

FIG. 9 is a diagram showing a configuration of a sensor for configuring sensor related augmenting content of the augmented broadcasting transmission apparatus according to the exemplary embodiment of the present invention. More than one camera 901, 902, and 903 and more than one actor 904, 905, and 906 are present in the production site of the broadcasting content. When the actor may not directly appear on a screen according to the program, in the exemplary embodiment of the present invention, a person progressing the corresponding programs may be considered as an actor. In addition, the exemplary embodiment of the present invention includes a case in which an actor is not a professional broadcaster as in a sports game and when numerous actors like a demonstration site are present, a sensor may be applied only to a part of actors. Cameras 901, 902, and 903 each include at least one sensor 901-1, 901-2, 901-3, 902-1, 902-2, 902-3, 903-1, 903-2, and 903-3. Each camera includes different number of sensors according to the amount of information occupied by the broadcasting programs and a camera that does not use the sensor may be used. The pan, tilt, zoom, and the like, of the camera may be measured by these sensors and the characteristics of the video at the location of the camera and the information described in FIG. 10 may be measured. Actors 904, 905, and 906 each include at least one sensor 904-1, 904-2, 904-3, 905-1, 905-2, 905-3, 906-1, 906-2, and 906-3. These sensors may measure several sensing information that is felt in terms of a actor. The production site of the augmented broadcasting content may include at least one site 907, 908, and 909 and at least one sensor 907-1, 907-2, 907-3, 908-1, 908-2, 908-3, 909-1, 909-2, and 909-3 may be disposed in each site to measure several sensing information that can be felt at the site. Only the sensor may be disposed at the place which wants to provide the sensing information to the viewer or the corresponding place which wants to provide the sensing information to the viewer, without disposing the sensor at all the sites. The additional data for the augmented broadcasting are transmitted by collecting the information that can be felt at a location or a site of the camera in the broadcasting production site and various sensing information that can be felt in terms of the actor. All the information collected by the sensors that are applied to the cameras, the actors, the sites and only some sensing information that wants to be transmitted to the viewer among the information may be transmitted.

FIG. 10 is a diagram in detail a structure of the broadcasting content and the sensor related augmenting content using the sensor of the augmented broadcasting transmission apparatus according to the exemplary embodiment of the present invention. As shown in FIG. 10, a sensor related augmenting content 1010 using the sensor according to the exemplary embodiment of the present invention may include a sensor type 1011, a sensor value, representing method 1013, and sensor values 1015, 1017, . . . , 1019. In addition, the augmented broadcasting content may include a broadcasting content 1020 and sensor related augmented broadcasting information 1030. The sensor related augmenting content 1010 using the sensor may be used as the augmented broadcasting information 1030.

The sensor value representing method 1013 represented according to the sensor type 1011 may be various. Any one representation method is determined and thus, the measured sensor values 1015, 1017, . . . , 1019 are determined and the broadcasting programs therefore and the augmented broadcasting information on the sensor values are represented. Here, the sensor type 1011 may include an acceleration sensor, an illumination sensor, a gyroscope, an earth magnetic sensor, a temperature sensor, an atmospheric pressure sensor, a water pressure sensor, a gravity sensor, a GPS, and the like, but is not limited thereto. In the exemplary embodiment of the present invention, a plurality of videos, a plurality of audios, and the like, are considered as each sensor information. The acceleration sensor can detect a speed of a photographing target (actor, a vehicle in which an actor rides, and the like) the illumination sensor can detect brightness around a photographing target, the gyroscope can detect a balance of photographing target, the earth magnetic sensor can detect a direction of a photographing target, the temperature sensor can detect temperature of the photographing target or therearound, the atmospheric pressure sensor can detect altitude information of the photographing target or therearound that is photographed using atmospheric pressure information, the water pressure sensor can detect depth information of an object or a water therearound that is photographed using the water pressure information, the gravity sensor can detect gravity information on a photographing target, and the GPS can detect a location or an altitude of a photographing target. Several situation information of the photographing targets or therearound can be detected by using these sensors.

The sensor value representing method 1013 may be changed according to producers or methods even though the sensors are the same type. However, the sensor value representing method 1013 may be omitted at all times when the values of the same system are applied.

The sensor values 1015, 1017, . . . , 1019 may be omitted when the values of the corresponding sensors do not provide special meanings to the users. That is, when the augmenting content is not provided independently of the sensor values 1015, 1017, . . . , 1019 or even though the sensor values 1015, 1017, . . . , 1019 are provided, the same augmenting content may be omitted. The number of sensor values 1015, 107, . . . , 1019 may be changed according to the sensor type 1011. These sensor types 1011, the sensor value representing method 1013, the sensor values 1015, 1017, . . . , 1019, and the augmented broadcasting information 1030 on the sensor values are the sensor related augmenting content to which the viewers want to watch, in connection with the corresponding sensors. In particular, when the plurality of programs may watch the same augmented broadcasting content with respect to the information one sensor and different augmented broadcasting content is watched according to the broadcasting programs, the augmented broadcasting information 1030 may be divided and managed according to the broadcasting content 1020. Here, the same augmented broadcasting content for the same sensor and the sensor values of one broadcasting program can also be viewed and may be subdivided so as to view different augmented broadcasting content for each turn of the broadcasting programs or each segment within one-time broadcasting program. Here, in the augmented broadcasting information 1030, the audio/video/data information of the augmenting content may also be disposed as it is but the location of the separately stored augmenting content or the information on the content provider having the augmenting content may be disposed.

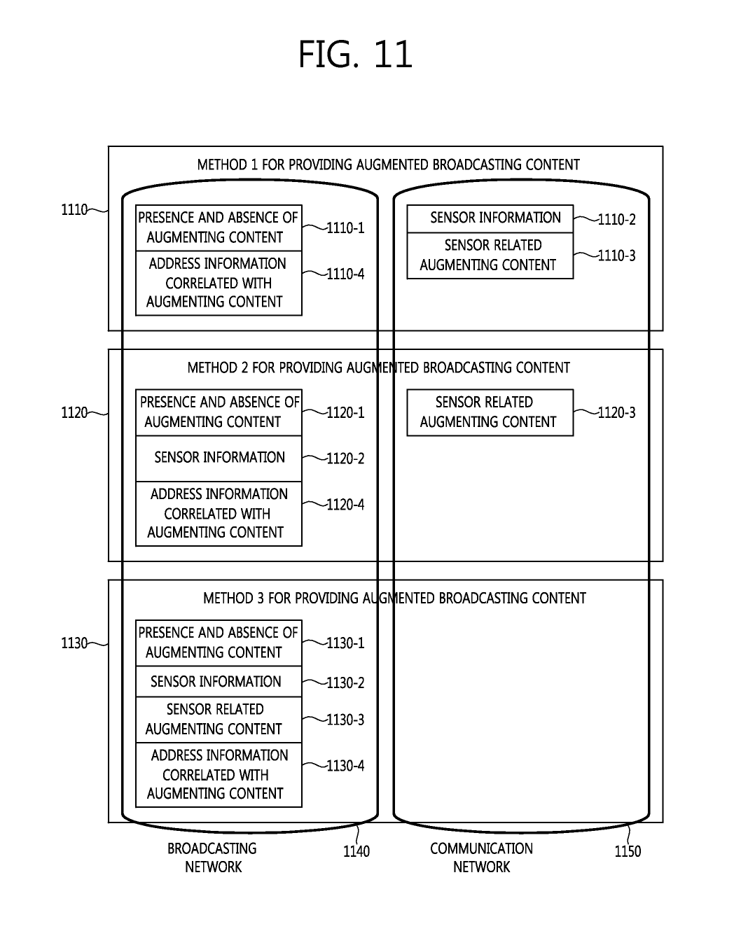

FIG. 11 is a diagram exemplarily showing three types of transmitting augmented broadcasting content of the augmented broadcasting transmission apparatus according to the exemplary embodiment of the present invention. As shown in FIG. 11, the augmented broadcasting transmission apparatus of the exemplary embodiment of the present invention may be provided through presence and absence of the augmenting content 1110-1, 1120-1, and 1130-1, sensor information 1110-2, 1120-2, and 1130-2, address information 1110-3, 1120-3, and 1130-3 correlated with the augmenting content, sensor related augmenting content 1110-4, 1120-4, and 1130-4 may be provided through the broadcasting network 1140 and the communication network 1150.

The additional data stream may be directly transmitted through the broadcasting network 1140 but when the amount of augmenting content is large, may be transmitted through the communication network 1150. First, if the amount of sensor information correlated with the augmented broadcasting content is large and thus, is larger than the capacity that can be transmitted from the additional data stream (1110), when the presence and absence 1110-1 of the augmenting content are informed as the additional data stream of the broadcasting network 1140, the viewer at the receiver side issues instructions or the terminal is automatically downloaded with the sensor information 610-2 and the sensor related augmenting content 1110-3 through the communication network 1150 without the viewer's intervention. In this case, address information 1110-4 correlated with the augmenting content may be transmitted together from the broadcasting network 1140. When the information is omitted, the information may also be received in the receiver through a stored default page of the corresponding broadcasting station. The default page may be received through an EPG, and the like. When the viewer is a viewer that does not have an interest in the augmented broadcasting, the augmenting content does not have to be downloaded and when the viewer is a viewer that has a great interest in the augmented broadcasting of the corresponding programs and is a viewer wanting to confirm the augmenting content, the augmenting content is downloaded from the address information 1110-4 correlated with the augmenting content. The download may be automatically set by a viewer and the setting of the download may be explicitly requested by the viewer if necessary.

Second, when the sensor information 1120-2 correlated with the augmenting content may be transmitted from the additional data stream but the augmenting content correlated therewith may be larger (1120) than the capacity that can be transmitted from the additional data stream of the broadcasting network 1140, the presence and absence 1120-1 of the augmenting content and the sensor information 1120-2 and the address information 1120-4 correlated with the augmenting content are transmitted to the additional data stream and the terminal are automatically downloaded with the sensor related augmenting content 1120-3 from the address information 1120-4 correlated with the augmenting content through the communication network 1150 at the receiver side by the viewer's instruction or without the viewer's intervention. In this case, the presence and absence 1120-1 of the augmenting content is omitted and only the sensor information 1120-2 may be used.

Third, when the amount of sensor related augmenting content is not large and thus, may be transmitted from the additional data stream of the broadcasting network 1140 (1130), the presence and absence 1130-1 of the augmenting content and the sensor information 1130-2 as well as the sensor related augmenting content 1130-3 may be transmitted to the additional data stream of the broadcasting network 1140. In this case, the presence and absence 1130-1 of the augmenting content and the sensor information 1130-2 are omitted and only the sensor related augmenting content 1130-3 may also be transmitted. Further, the address information 1130-4 correlated with the augmenting content is transmitted together and thus, the user can additionally confirm the information 1130-4 correlated with the augmenting content.

In the above cases, the address information 1110-4, 1120-4, and 1130-4 correlated with the augmenting content may indicate the address informing the information correlated with the augmenting content from the portal providers or the content providers generally present in the communication network 1150 but may indicate the specific location of the auxiliary storage device of the terminal. Three cases of FIG. 11 are described based on the case in which the amount of augmenting content is large and small, but even though the amount thereof is small, in the case in which the augmenting content or the metadata are received from the content providers or the portal providers rather than from the broadcasting network 1140 (according to character of content, providing methods, and the like), the third case 1130 cannot be applied and only the first case 1110 and the second case 1120 can be applied.

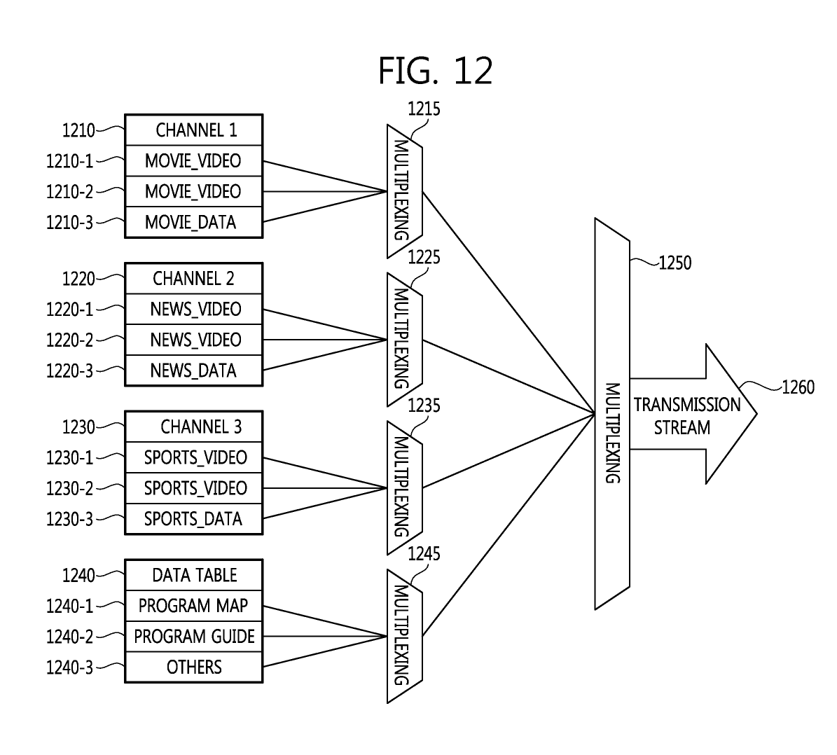

FIG. 12 is a diagram showing the multiplexing of the augmented broadcasting content when the augmented broadcasting transmission apparatus according to the exemplary embodiment of the present invention uses MPEG-2. The augmented broadcasting transmission apparatus according to the exemplary embodiment of the present invention may use H.264, MPEG-4, or MPEG-2 as the encoding technology. FIG. 12 shows the case of using the MPEG-2 among them.

When the augmented broadcasting transmission apparatus uses the MPEG-2, one transmission channel 1260 received by the viewer is configured of at least one logical channel 1210, 1220, 1230, and 1240, wherein each logical channel 1210, 1220, 1230, and 1240 is the augmented broadcasting content provided to the viewer or additional information correlated with the augmented broadcasting content included in the transmission channel. For example, in the case of channel 1 1210 that is a movie channel, the channel 1 1210 may be configured of video 1210-1 and audio 1210-2 of the movie and metadata 1210-3 correlated with the movie, which may be multiplexed together.

Referring to FIG. 7, the multiplexing (740) function has the same function as multiplexing 1215 of FIG. 12. That is, the video 731 may be parsed as videos 1210-1, 1220-1, and 1230-1, the audio 733 may be parsed as audios 1210-2, 1220-2, and 1230-2, the data 735 may be parsed as data 1210-3, 1220-3, and 1230-3, by the same function and apparatus.

Referring back to FIG. 12, as another example, a news channel 1220, a sports channel 1230, and the like, are configured by the same method. Each of the videos 1210-1, 1220-1, and 1230-1 or the audios 1210-2, 1220-2, and 1230-2 for each channel may be encoded. Meanwhile, the information on each logical channel or all the transmission channels may additionally be provided as the information on the data table 1240. For example, the data table 1240 may include a program map 1240-1 that informs that each channel is present in any location among all the multiplexing streams 1260, a guide 1240-2 of programs providing an organization table of programs using the transmission channel, or other clocks or other information 1240-3. The information of each logical channel is multiplexed 1215, 1225, 1235, and 1245 for each logical channel and is entirely multiplexed 1250 and is provided in the type of the transmission stream 1260. The augmented broadcasting content to which the present invention is applied may be include in the metadata areas 1210-3, 1220-3, and 1230-3 of each logical channel.

### Augmenting Content Generating Apparatus

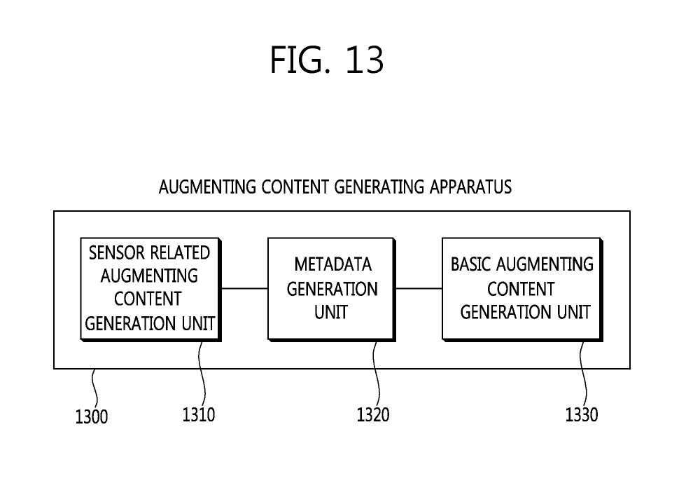

FIG. 13 is a block diagram schematically showing an augmenting content generation apparatus 1300 according to another exemplary embodiment of the present invention. The augmenting content generating apparatus 1300 according to the exemplary embodiment of the present invention is an apparatus that generates the augmenting content transmitted by being added to the broadcasting content. As shown in FIG. 13, the augmenting content generating apparatus 1300 according to the exemplary embodiment of the present invention may include an augmenting content generation unit 1310, a metadata generation unit 1320, and a basic augmenting content generation unit 1330.

The augmenting content generation unit 1310 uses a plurality of sensors to acquire various sensing information and serves to generate at least one sensor related augmenting content based on the acquired sensing information. The sensing information is sensed by different sensors and thus, may be acquired in plural. The sensor related augmenting content generated based thereon may be in plural. Therefore, as described above, several sensor related augmenting content may be generated in a single broadcasting content and several types of augmented broadcasting may be produced according to the selection of the content producers or the receiving side. The generated sensor related augmenting content provides the augmented broadcasting by being summed with the broadcasting content later.

The sensor related augmenting content and the correlation information of the broadcasting content and the augmenting content may be provided based on the sensed information and the correlation information is transmitted to the metadata generation unit 1320 and then, is transmitted to the receiving side in the additional data stream type. In addition, according to the augmenting content generating apparatus 1300 of the exemplary embodiment of the present invention, another basic augmenting content may also be directly generated through the basic augmenting content generation unit 1330, in addition to the sensor related augmenting content.

The metadata generation unit 1320 generates the metadata including the individual augmenting content correlated information. The metadata generation unit 1320 receives the correlation information of the sensor related augmenting content and the broadcasting content from a sensing information generation unit 1400 to generate the metadata. In addition, the metadata generation unit 1320 may receive the correlation information of the basic augmenting content and the broadcasting content to generate the metadata. In particular, the metadata generation unit 630 of FIG. 6 defines the general character of the augmenting content correlated with the corresponding broadcasting content, while the metadata generation unit 1320 defines the character of the metadata correlated with the individual augmented content generated. In other words, the metadata generation unit 630 defines all the metadata that are applied to various augmenting content that may be provided by the plurality of content providers applicable to a single broadcasting content but the metadata generation unit 1320 defines the character of the individual augmenting content prepared by the individual content providers.

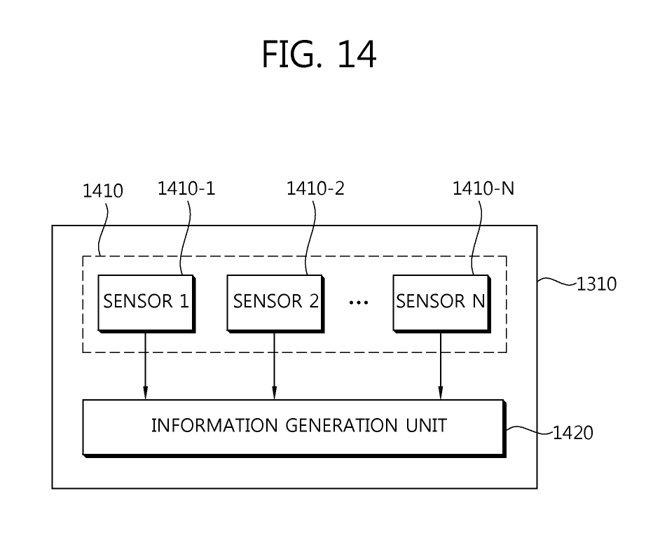

FIG. 14 is a detailed block diagram showing in detail the sensing information generation unit 1400 according to another exemplary embodiment of the present invention. As shown in FIG. 14, the sensing information generation unit 1400 according to the exemplary embodiment of the present invention may include a sensing information collection unit 1410 and an information generation unit 1420.

Referring to FIG. 14, the sensing information generation unit 1400 includes the sensing information collection unit 1410. Here, it can be appreciated that the sensing information collection unit 1410 may be configured of a plurality of sensors. For example, sensor 1 1410-1 may be a sensor that is attached to the camera to sense the information on tilt, zoom, and the like, of the camera. Sensor 2 1410-2 may be a sensor that senses a current state of a photographing object. The sensing information sensed and acquired by the sensor 1 1410-1 is transmitted to the information generation unit 1420. Similarly, the information sensed by the sensor 2 1410-2 is also transmitted to the information generation unit 1420. The information generation unit 1420 collects and arranges the information from the plurality of sensors. In this case, the information generation unit may perform operations of unifying the method for representing the values of the sensor data or removing the overlapping data, and the like. The acquired sensing information is transmitted to the augmenting content generation unit 1310 to generate the sensor related augmenting content.

The information generation unit 1420 receives various sensing information from the plurality of sensors 1410 and transmits the received sensing information to the augmenting content generation unit 1310 and the metadata generation unit 1320.

### Augmenting Broadcast Reception Apparatus

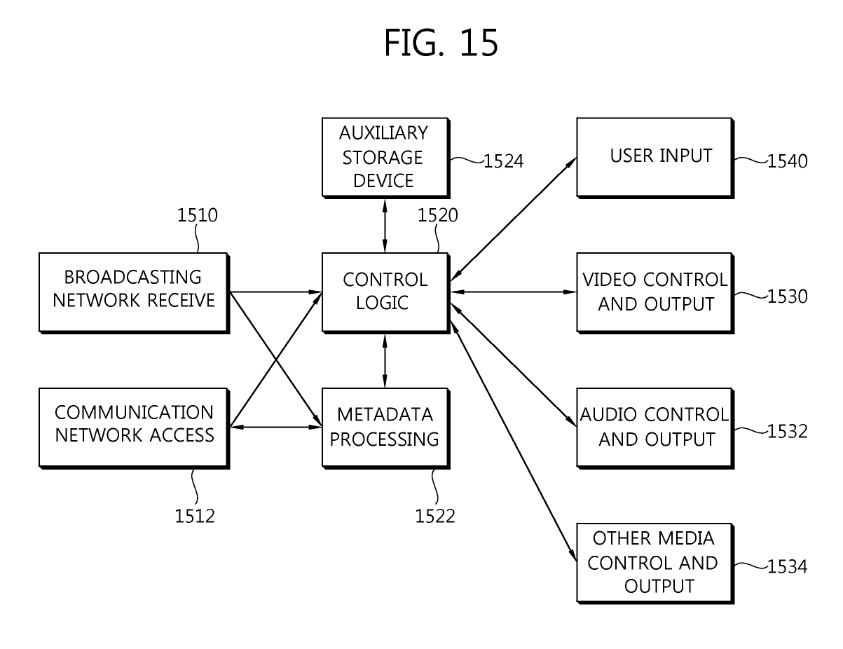

FIG. 15 is a functional configuration diagram of an augmented broadcasting reception apparatus according to another exemplary embodiment of the present invention. As shown in FIG. 15, the reception apparatus first has a broadcasting network receiving 1510 function and a communication network connecting 1512. The broadcasting network receiving 1510 function has a protocol layer that can receive the information of the transmission stream transmitted in digital broadcasting. A control logic 1520 parses other information including broadcasting content transmitted through the broadcasting network to determine whether there is a need to process the metadata and request the processing of the metadata to a metadata processing 1522 function. When there is a need to acquire the augmenting content while seeing the metadata, the augmenting content is received through the communication network. An auxiliary storage device 1524 function means a function of storing content for again using the broadcasting content and the augmenting content later. The communication network connection 1512 function has a function of processing protocols necessary for the wired and wireless communication network connection. The control logic 1520 processes the matching/synthesizing/synchronizing with the broadcasting content on the received augmenting content and outputs the processed content for each media. The function of matching, synthesizing, and synchronizing between the broadcasting content and the augmenting content is separated from the control logic 1520 and thus, may also be realized as the separate function block. A video control and output 1530 function serves to output video information of the broadcasting content and the augmenting content together, an audio control and output 1532 function serves to output audio information of the broadcasting content and the augmenting content together, and other media control and output 1534 function serves to output other media information of the augmenting content. A user input 1540 function processes a user input in the augmented broadcasting reception apparatus and may process the input based on the remote controller according to the related art and the motion of the user or various input types.

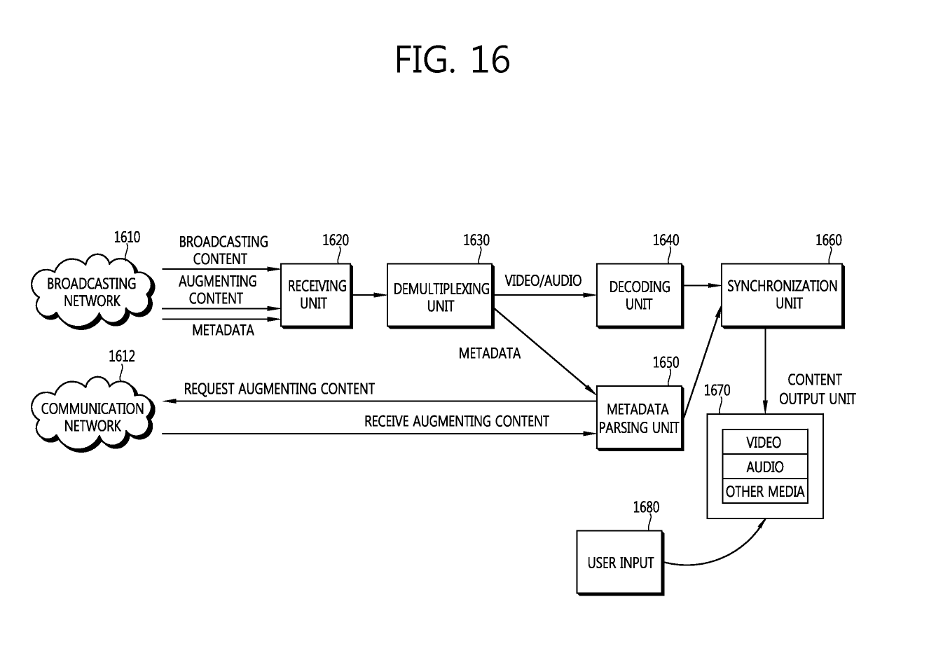

FIG. 16 is a block diagram schematically showing an augmented broadcasting reception apparatus according to another exemplary embodiment of the present invention. The augmented broadcasting reception apparatus according to the embodiment of the present invention may be digital TV, digital radio, PCs, notebooks, PDAs, smart phones, wired and wireless terminals, mobile terminals, and the like. As shown in FIG. 16, the augmented broadcasting reception apparatus according to the exemplary embodiment of the present invention may include a receiving unit 1620, a demultiplexing unit 1630, a decoding unit 1640, a metadata parsing unit 1650, a synchronization unit 1660, and a content output unit 1670.

The receiving unit 1620 receives the broadcasting content, the augmenting content including the sensor related augmenting content including the sensing information, and the metadata through the broadcasting network 1610. The receiving unit 1620 performs demodulation and error correction, and the like, on the received content. All the augmenting content among the content may be transmitted to the broadcasting network 1610, but when the augmenting content is divided and transmitted through the communication network 1612 in addition to the broadcasting network 1610 at the transmitting side, the receiving unit 1620 does not receive all the augmenting content. In this case, the metadata parsing unit 1650 may request and request the augmenting content that is not received through the broadcasting network. Although not shown in the exemplary embodiment of the present invention, the content and the metadata may be transmitted through the communication network 1612 and therefore, the receiving unit 1620 may acquire the transmitted content and metadata through the communication network 1612.

The demultiplexing unit 1630 demultiplexes the broadcasting content, the augmenting content, and the metadata that are received through the receiving unit 1620. The content received through the receiving unit 1620 is a content that is multiplexed and transmitted by the transmission apparatus and therefore, the video, audio, and data each need to be differently parsed, thereby demultiplexing all the content.

The decoding unit 1640 decodes the video and the audio of the broadcasting content and the augmenting content that is demultiplexed by the demultiplexing unit 1630. The audio and the video may each be decoded according to the encoded type and may be decoded together. After being decoded, for synchronization between the broadcasting content and the augmenting content, it takes time to receive the augmenting content requested by the metadata parsing unit 1650. Therefore, the broadcasting content may be buffered. This is performed in the buffering unit (not shown). The buffering unit needs to consume a predetermined time to fetch the augmenting content from the communication network based on the metadata and therefore, may delay the play of the broadcasting content for media synchronization until the augmenting content is completely fetched. In addition, for media synchronization, the metadata correlated with the augmenting content of next programs are previously transmitted during the current telecasting of programs and thus, the reception apparatus may fetch the augmenting content from the server and the content providers and synchronize the fetched augmenting content, thereby controlling the schedule.

The metadata parsing unit 1650 may parse the metadata demultiplexed by the demultiplexing unit 1630 and thus, may request and receive the augmenting content. The parsing of the metadata is performed by performing the decoding meeting the encoded type at the receiving side when the metadata are encoded at the transmitting side. Since the information on the augmenting content is included in the metadata, the required augmenting content is requested to the communication network 1612 according to the parse analysis of the metadata and the results thereof may be received. The augmenting content requested and received by the metadata parsing unit 1650 may be synchronized with the broadcasting content and the augmenting content received through the broadcasting network and may be output.

The synchronization unit 1660 receives the video and the audio decoded by the decoding unit 1640 and the additional augmenting content received by the request of the metadata parsing unit 1650 to perform synchronization with the broadcasting content. As described above, in order to easily perform the media synchronization, the embodiment of the present invention may use a method of buffering broadcasting content through the buffering unit (not shown).

The content output unit 1670 outputs the synchronized content from the synchronization unit 1660. This may be visually output in a display type, but may also be output as voice through a speaker, and the like. Further, the synchronized content may also be output through the display, the speaker, and the like, together. In addition, the synchronized content may be output by being added to the audio or the video according to the type of the augmenting content or may be output in other media types as well as may be output in one of the above three types. As an example of other media, the synchronized content may be output in various types such as vibration, wind, perfume, and the like. The types of output for several media may be controlled by a viewer through a viewer input 1680. The viewer can control a degree of an output for the same information even if the brightness of the screen or the volume size of the speaker is controlled. When the golf course is watched as the augmented broadcasting content, it is possible to implement a function of watching the course at various angles according to the viewer input.

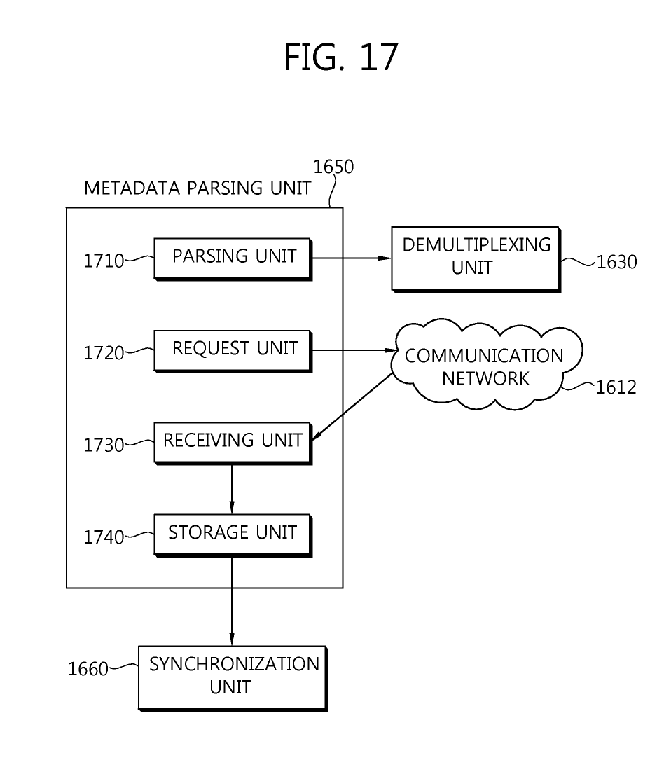

FIG. 17 is a detailed block diagram in detail showing a metadata parsing unit 1650 of an augmented broadcasting reception apparatus according to another exemplary embodiment of the present invention. As shown in FIG. 17, the metadata parsing unit 1650 according to the exemplary embodiment of the present invention may include a parsing unit 1710, a requesting unit 1720, a receiving unit 1730, and a storing unit 1740.

The parsing unit 1710 receives the metadata demultiplexed by the demultiplexing unit 1630 and pareses the received metadata. In this case, the parsing unit 1710 consumes a predetermined time to receive the augmenting content to be requested and received through the communication network and therefore, may previously receive and parse the metadata from the demultiplexing unit 1630 for facilitating the media synchronization. In this case, the augmented broadcasting reception apparatus according to the exemplary embodiment of the present invention includes a configuration that parses the metadata and selects whether the viewer watches the augmenting content when there are the augmenting content. For example, when a viewer watches basketball game as the broadcasting content, the viewer can clearly know a content (for example, information of a player or a stadium) to be provided from the augmenting content correlated with the basketball game. In this case, the augmenting content correlated with the basketball game may be configured to hinder the watching of the viewer. In this case, the viewer can watch only the broadcasting content to which he/she wants to watch by selecting that he/she does not watch the augmenting content. In addition, the selection on whether the augmenting content is watched may be automatically set.

The request unit 1720 serves to request the necessary augmenting content to the communication unit 1612 according to the metadata parsed by the parsing unit 1710 and the receiving unit 1730 serves to receive the augmenting content requested from the request unit 1720 from the communication network 1612. In this case, the storage unit 1740 serves to store the augmenting content received by the receiving unit 1730, if necessary. The storage unit 1740 stores the augmenting content received by the receiving unit 1730 for a predetermined time for the media synchronization. The storage unit 1740 may generally be the auxiliary storage device of the terminal.

Referring to FIG. 11, the request unit 1720 and the receiving unit 1730 need to request and receive the augmenting content 1110-2, 1110-3, and 1120-3 in the first case 1110 or the second case 1120 that includes only the presence and absence of the augmenting content 1110-1 and 1120-1 or the sensor information 1120-2 according to the parsing of the metadata. In the case of the third case 1130 including the augmenting content, the request and the reception may be processed internally. In addition, even in the first case 1110 or the second case 1120, the request and the reception may be processed internally even when the necessary augmenting content 1110-2, 1110-3, and 1120-3 are stored in the storage unit 1740 such as the auxiliary storage device of the terminal.

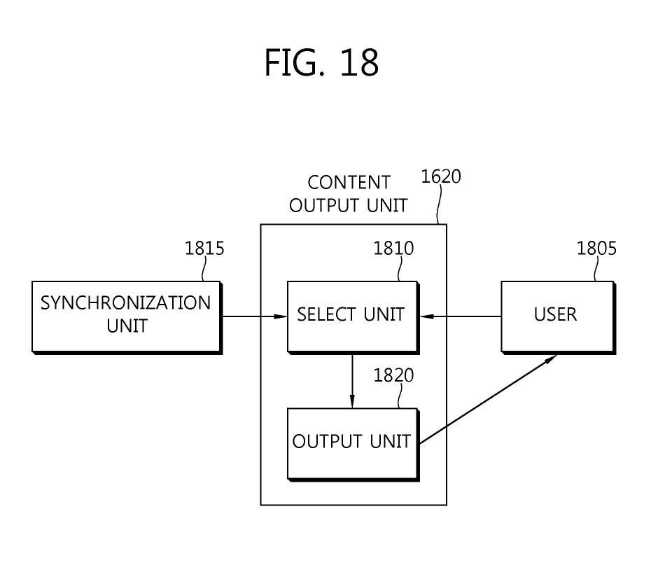

FIG. 18 is a detailed block diagram in detail showing a content output unit of an augmented broadcasting reception apparatus according to another exemplary embodiment of the present invention. A shown in FIG. 18, the content output unit 1670 may include a select unit 1810 and an output unit 1820.

The select unit 1810 receives as an input the augmenting content selected by a user 1805 among various augmenting content and added to the broadcasting content, from the user 1805. That is, when wanting to watch the camera related sensing information added to the broadcasting content in the sensor related augmenting content, the corresponding information can be watched by selecting the camera related sensing information through the user interface. The selection information of the user is again feedback to the synchronization unit 1815 and thus, the synchronization unit 1815 performs the synchronization between the corresponding augmenting content and the broadcasting content and then, outputs the synchronized content through the output unit 1820. In this case, the user 1805 may want to watch the augmenting content by changing the position, size, and the like, of the augmenting content. In this case, the augmenting content selected through the select unit 1810 may be provided in the user desired type.

The output unit 1820 outputs the augmenting content and the broadcasting content provided from the select unit 1810 to the user. Before being output, the selected augmenting content and broadcasting content need to be synchronized with each other. That is, the selected augmenting content is synchronized with the broadcasting content by the synchronization unit 1815 and the synchronized augmented broadcasting content is output through the output unit 1820. The user 1805 selects other augmenting content through the above processes while watching the output augmented broadcasting content and may watch the selected augmenting content in another type.

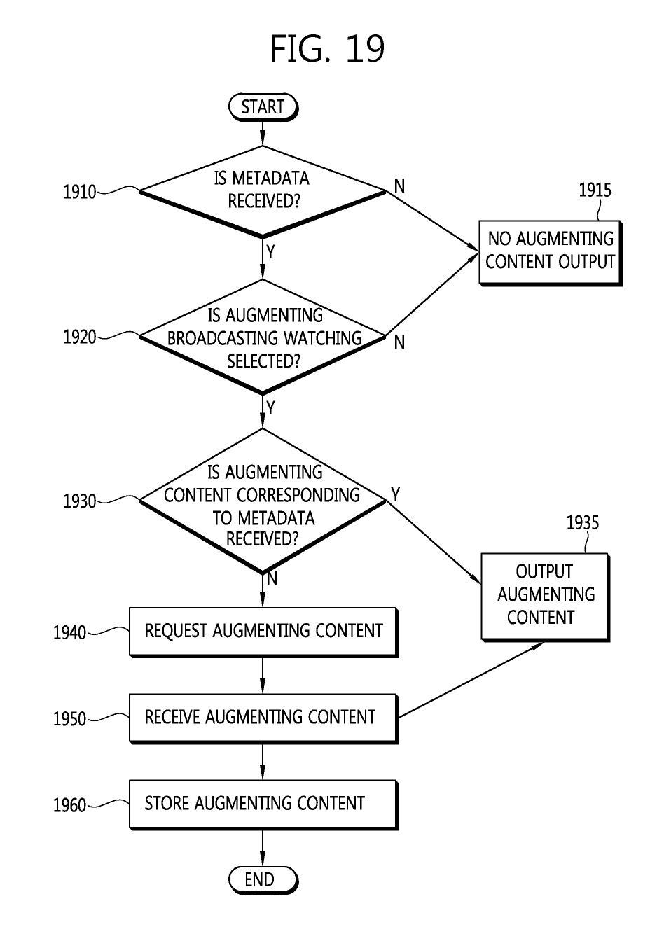

FIG. 19 is a flow chart for describing a method of determining whether augmenting content is output according to a reception of metadata by a metadata parsing unit 1650 of an augmented broadcasting reception apparatus according to another exemplary embodiment of the present invention. The metadata parsing unit 1650 demultiplexes the augmented broadcasting content and then, confirms the presence and absence of the metadata before the metadata are parsed (1910). When the metadata are not present, the metadata do not include the sensor information, the presence and absence of the augmented broadcasting content is not present, or the presence and absence of the augmented broadcasting content does not include the sensor related augmenting content, the augmenting content is not output (1915). In addition, even though the sensor related augmenting content is present, when the viewer does not select the watching of the augmented broadcasting (1920), the augmenting content is not output (1915). If it is determined that the augmenting content is received in advance by parsing the metadata, the related augmenting content is output (1930). If it is determined that the augmenting content is not yet received, the augmenting content is requested (1940) and received (1950). The received augmenting content may be output (1935) and when the received augmenting content needs to be stored, they are stored and thus, may be reused later (1960). The augmented broadcasting content fetched from the auxiliary storage device of the terminal may be output.

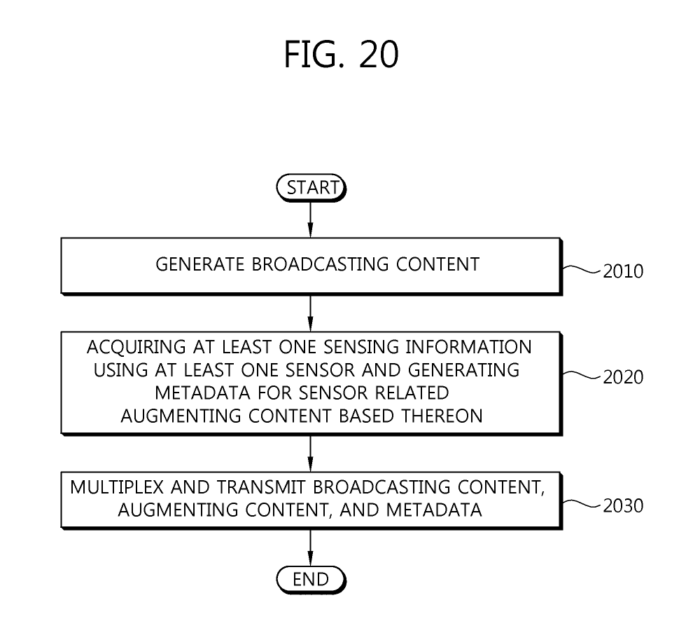

FIG. 20 is a flow chart schematically showing an augmented broadcasting transmission method according to an exemplary embodiment of the present invention. As shown in FIG. 20, the augmented broadcasting transmission method according to the exemplary embodiment of the present invention includes generating broadcasting content (2010), acquiring at least one sensing information using at least one sensor and generating metadata for sensor related augmenting content based on the acquired sensing information (2020), and controlling transmission by performing multiplexing based on the broadcasting content, the augmenting content, and the metadata (2030). The augmented broadcasting transmission method is the same as the process of the foregoing augmented broadcasting transmission apparatus and the overlapping description thereof will be omitted.

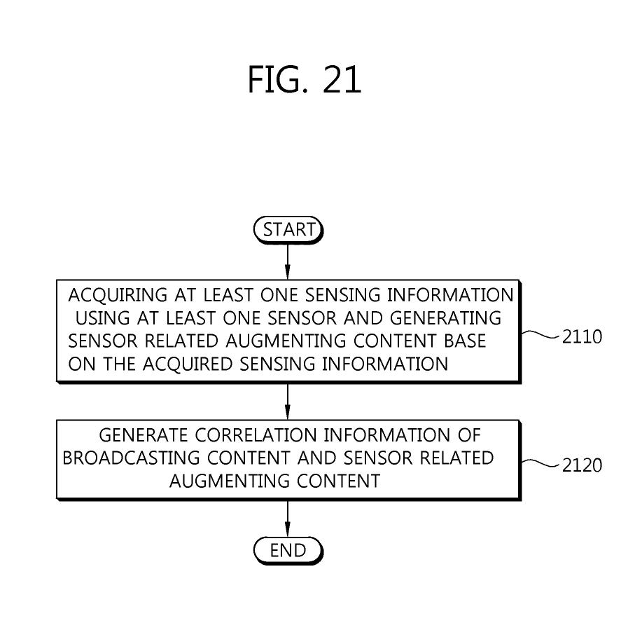

FIG. 21 is a flow chart schematically showing an augmenting content generation method according to another exemplary embodiment of the present invention. As shown in FIG. 21, the augmenting content generation method according to the exemplary embodiment of the present invention is a method for generating sensor related augmenting content correlated with broadcasting content, wherein the method may include: acquiring at least one sensor information using at least one sensor and generating at least one sensor related augmenting content correlated with the broadcasting content based on the acquired sensing information (2110) and generating correlation information of the broadcasting content and the sensor related augmenting content (2120). The augmenting content generation method is the same as the process of the foregoing augmenting content generation apparatus and the overlapping description thereof will be omitted.

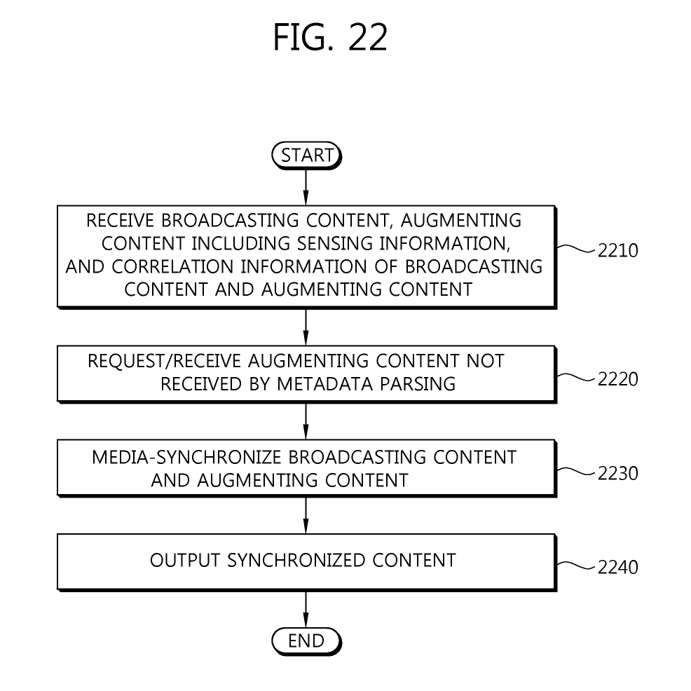

FIG. 22 is a flow chart schematically showing an augmented broadcasting reception method according to another exemplary embodiment of the present invention. As shown in FIG. 22, the augmented broadcasting reception method according to the exemplary embodiment of the present invention may include: receiving broadcasting content, augmenting content correlated with the broadcasting content and augmenting content including sensing information acquired through at least one sensor, and metadata including correlation information of the broadcasting content and the augmenting content through a broadcasting network 2210; parsing the metadata to request and receive the augmenting content that is not received through the broadcasting network through a communication network 2220; media-synchronizing the broadcasting content and the augmenting content 2230; and outputting the synchronized content 2240. The augmented broadcasting reception method is the same as the process of the foregoing reception apparatus of the augmenting method and the overlapping description thereof will be omitted.

According to the augmenting content generating apparatus and method, the augmented broadcasting transmission apparatus and method, and the augmented broadcasting reception apparatus and method, it is possible to more realistically transfer the sense of realism of the broadcasting programs to the viewer by providing the information acquired by the sensor at the production site of the broadcasting program to the viewer.

In addition, according to the augmenting content generating apparatus and method, the augmented broadcasting transmission apparatus and method, and the augmented broadcasting reception apparatus and method, it is possible to provide the information acquired by the sensor at the time of producing the augmented broadcasting content and the information correlated therewith as various content and types of the augmenting content and it is possible for a viewer to select the augmenting content meeting its own taste among the content and enjoy the selected augmenting content in its own preferred type.

Further, according to the augmenting content generating apparatus and method, the augmented broadcasting transmission apparatus and method, and the augmented broadcasting reception apparatus and method, it is possible to effectively use the digital TV broadcasting and the digital radio broadcasting in the type using the broadcasting network and the communication network together. The digital TV broadcasting and the digital radio broadcasting terminal can be expected to be gradually output the new media together while the stereo speaker and the SD type display according to the related art are gradually developed to the 5.1 channel/7.1 channel speaker, the HD type/UHD type, and the like. The exemplary embodiments of the present invention can use the augmented broadcasting services even in the digital radio broadcasting by additionally providing the information acquired by the sensor to the viewer at the time of producing the broadcasting content based on the TV and the audio.

Although the exemplary embodiments of the present invention will be described with reference to the accompanying drawings, the scope of the present invention is not construed as being limited to the drawings or the exemplary embodiments. It will be apparent to those skilled in the art that modifications and variations can be made without departing from the spirit and scope of the invention as defined by the appended claims.

What is claimed is:

1. An augmented broadcasting transmission apparatus, comprising:
a broadcasting content generation unit that generates broadcasting content;
a metadata generation unit that generates metadata acquiring at least one sensing information using at least one sensor and outputting sensor related augmenting content based on the acquired sensing information; and
a control unit that controls transmission by performing multiplexing based on said broadcasting content and the metadata.

2. The augmented broadcasting transmission apparatus of claim 1, further comprising: a basic augmenting content generation unit that generates basic augmenting content.

3. The augmented broadcasting transmission apparatus of claim 1, wherein said control unit multiplexes and transmits the broadcasting content, the augmenting content, and the metadata into a video stream type, an audio stream type, and a data stream type.

4. The augmented broadcasting transmission apparatus of claim 1, wherein said control unit transmits the broadcasting content among said augmented broadcasting content generated by multiplexing said augmenting content and said broadcasting content through a broadcasting network, transmits said augmenting content through different transmission networks according to the amount and characteristics of the augmenting content, (i) transmits all of the augmenting content through said broadcasting network, (ii) transmits a part of said augmenting content through said broadcasting network and additionally transmits the rest augmenting content that is not provided from said broadcasting network through a communication network, and (iii) transmits all of said augmenting content through said communication network.

5. The augmented broadcasting transmitting apparatus of claim 1, wherein said at least one sensor is applied to a camera, an actor, or a broadcasting site participating in broadcasting, and said sensor senses pan and tilt information of a camera when said sensor is applied to said camera.

6. The augmented broadcasting transmitting apparatus of claim 1, wherein said augmented broadcasting transmitting apparatus uses any one of H.264, MPEG-4, or MPEG-2 to transmit said augmented broadcasting content.

7. The augmented broadcasting transmission apparatus of claim 6, wherein when said augmented broadcasting transmission apparatus transmits said augmented broadcasting content using an MPEG-2, said augmented broadcasting content is transmitted to a single transmission channel and said single transmission channel is configured of at least one logical channel, and each logical channel includes additional information related to said augmented broadcasting content provided to the receiving side or said augmented broadcasting content included in said transmission channel.

8. An apparatus for generating sensor related augmenting content correlated with broadcasting content, comprising:
a sensor relating augmenting content generation unit that acquires at least one sensing information using at least one sensor and generates said sensor related augmenting content correlated with said broadcasting content based on said acquired sensing information; and
a metadata generation unit that generates metadata including correlation information of said sensor related augmenting content said the broadcasting content.

9. The apparatus of claim 8, further comprising: a basic augmenting content generation unit that generates basic augmenting content.

10. An augmented broadcasting reception apparatus, comprising:
a content receiving unit that receives broadcasting content, augmenting content correlated with said broadcasting content and including sensing information acquired through at least one sensor, and metadata including correlation information of the broadcasting content and said augmenting content through a broadcasting network;
a metadata parsing unit that pares the metadata to request and receive said augmenting content that is not received through said broadcasting network through a communication network;
a synchronization unit that media-synchronizes said broadcasting content and said augmenting content; and
a content output unit that outputs said synchronized content.

11. The augmented broadcasting reception apparatus of claim 10, wherein said content output unit includes:
a select unit that allows a user to receive as an input a selection for said augmenting content to be added to said broadcasting content among said augmenting content and provides the selected augmenting content in the user's desired type; and
an output unit that outputs said augmenting content and said broadcasting content provided from said select unit.

12. The augmented broadcasting reception apparatus of claim 11, wherein said select unit receives the selection for said sensor related augmenting content to be added to said broadcasting content as an input and provides said selected augmenting content in the user's desired type.

13. The augmented broadcasting reception apparatus of claim 10, wherein said metadata parsing unit includes:
a parsing unit that parses said metadata;
a request unit that requests said augmenting content that is not received through said broadcasting network according to said parsed metadata;
a receiving unit that receives said requested augmenting content; and
a storage unit that stores said received augmenting content for the media synchronization for a predetermined time.

14. The augmented broadcasting reception apparatus of claim 10, further comprising: a buffering unit that buffers said broadcasting content until said augmenting content that is not received from said content receiving unit are received so as to facilitate media synchronization of said broadcasting content and said augmenting content.

15. The augmented broadcasting reception apparatus of claim 10, wherein said metadata parsing unit previously receives and parses said metadata so as to facilitate the media synchronization since it takes time to receive said augmenting content that is not received through said broadcasting network through said communication network.

16. The augmented broadcasting reception apparatus of claim 10, wherein said augmented broadcasting parsing unit further includes an augmented broadcasting watching select unit that selects whether said augmenting content is watched and if it is determined that said augmenting content is not watched, does not output the augmenting content.

17. The augmented broadcasting reception apparatus of claim 16, wherein said metadata parsing unit transmits said augmenting content correlated with said metadata to said synchronization unit when said augmenting content correlated with said metadata is included in said augmenting content received through said broadcasting network and a request unit requests said augmenting content correlated with said metadata parsed by said parsing unit through the communication network when said augmenting content correlated with said metadata is not included in said augmenting content received through said e broadcasting network.

18. An augmented broadcasting transmission method, comprising:
generating broadcasting content;
acquiring at least one sensing information using at least one sensor and generating metadata outputting sensor related augmenting content based on said acquired sensing information; and
controlling transmission by performing multiplexing based on said broadcasting content, the augmenting content, and said metadata.

19. A method for generating augmenting content correlated with broadcasting content, comprising:
acquiring at least one sensing information using at least one sensor and generating at least one sensor related augmenting content correlated with said broadcasting content based on said acquired sensing information; and
generating metadata including correlation information of said broadcasting content and said sensor related augmenting content.

20. An augmented broadcasting receiving method, comprising:
receiving broadcasting content, augmenting content correlated with said broadcasting content and augmenting content including sensing information acquired through at least one sensor, and metadata including correlation information of said broadcasting content and said augmenting content through a broadcasting network;
parsing said metadata to request and receive said augmenting content that is not received through said broadcasting network through a communication network;
media-synchronizing said broadcasting content and the augmenting content; and
outputting said synchronized content.
